(19) United States
(12) Patent Application Publication
(10) Pub. No.: US 2025/0133136 A1
(43) Pub. Date: Apr. 24, 2025

(54) Remote Memory Filling

(71) Applicant: MELLANOX TECHNOLOGIES, LTD., Yokneam (IL)

(72) Inventor: Dotan Barak, Zichron Yaakov (IL)

(21) Appl. No.: 18/491,820

(22) Filed: Oct. 23, 2023

(51) Int. Cl. H04L 67/1097; H04L 67/1095

(52) U.S. Cl. CPC H04L 67/1097; G06F 13/1657; G06F 13/404; G06F 15/17331; H04L 67/1095

(57) ABSTRACT

A network adapter includes a port and circuitry. The port is to connect to a communication network. The circuitry is to send to a remote network adapter, via the communication network, a remote memory-set instruction that instructs the remote network adapter to fill one or more address ranges in a memory with multiple copies of one or more fill-data values.

### FIELD OF THE INVENTION

The present invention relates generally to computer networks, and specifically to remote direct memory access (RDMA) over a computer network.

### BACKGROUND

Remote Direct Memory Access (RDMA) is a technique that allows direct memory access from the memory of one computer into that of another without involving either one's operating system. RDMA is described, for example, in “Mellanox RDMA Aware Networks Programming User Manual,” Rev. 1.7 (2015).

Another background reference is U.S. Patent 6, 122, 659, which discloses a shared memory parallel processing system interconnected by a multi-stage network combines new system configuration techniques with special-purpose hardware to provide remote memory accesses across the network, while controlling cache coherency efficiently across the network.

Lastly, U.S. Patent 8, 374,175 discloses a system and method for remote direct memory access over a network switch fabric, including a system comprising a first system node, a direct memory access (DMA) controller, a second system node, and a network switch fabric coupling together the first and second system nodes, wherein the DMA controller is configured to perform a DMA transfer of data between the first and second system nodes across the network switch fabric.

### SUMMARY

An embodiment of the present invention that is described herein provides a network adapter including a port and circuitry. The port is to connect to a communication network. The circuitry is to send to a remote network adapter, via the communication network, a remote memory-set instruction that instructs the remote network adapter to fill one or more address ranges in a memory with multiple copies of one or more fill-data values.

In some embodiments, the remote memory-set instruction includes an address-range indicator that indicates the one or more address ranges. Additionally or alternatively, the remote memory-set instruction may include a fill-data indicator that indicates the one or more fill-data values. In an embodiment, the circuitry is to receive, from a host, a command specifying the one or more address ranges and the one or more fill-data values, and to send the remote memory-set instruction in response to the command.

There is additionally provided, in accordance with an embodiment that is described herein, a network adapter including a port and circuitry. The port is to connect to a communication network. The circuitry is to receive from a remote network adapter, via the communication network, a remote memory-set instruction that instructs the network adapter to fill one or more address ranges in a memory with multiple copies of one or more fill-data values, and to execute the remote memory-set instruction by writing the one or more fill-data values multiple times to the one or more address ranges.

In some embodiments, the remote memory-set instruction includes an address-range indicator that indicates the one or more address ranges. Additionally or alternatively, the remote memory-set instruction may include a fill-data indicator that indicates the one or more fill-data values.

There is also provided, in accordance with an embodiment that is described herein, a method including, in a network adapter, connecting to a communication network. A remote memory-set instruction is sent from the network adapter to a remote network adapter via the communication network. The remote memory-set instruction instructs the remote network adapter to fill one or more address ranges in a memory with multiple copies of one or more fill-data values.

There is also provided, in accordance with an embodiment that is described herein, a method including, in a network adapter, connecting to a communication network. A remote memory-set instruction is received in the network adapter from a remote network adapter via the communication network. The remote memory-set instruction instructs the network adapter to fill one or more address ranges in a memory with multiple copies of one or more fill-data values. The remote memory-set instruction is executed using the network adapter, by writing the one or more fill-data values multiple times to the one or more address ranges.

There is further provided, in accordance with an embodiment that is described herein, a storage controller including a host interface, a memory interface and a processor. The host interface is to communicate with a host. The memory interface is to access a memory. The processor is to receive from the host, via the host interface, a command specifying one or more address ranges and one or more fill-data values, and, in response to the command, fill the one or more address ranges in the memory with multiple copies of the one or more fill-data values, by writing the one or more fill-data values multiple times to the one or more address ranges.

In some embodiments the command includes an address-range indicator that indicates the one or more address ranges. In some embodiments the command includes a fill-data indicator that indicates the one or more fill-data values.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a distributed compute system, including a pair of compute nodes that execute a remote memory-set instruction over a communication network, in accordance with an embodiment of the present invention;

FIG. 2 is a a block diagram that schematically illustrates an Initiator Network Adapter, in accordance with an embodiment of the present invention;

FIG. 3 is a block diagram that schematically illustrates a Target Network Adapter, in accordance with an embodiment of the present invention;

FIG. 4 is a diagram that schematically describes various Remote-Memory-Set request formats, in accordance with an embodiment of the present invention; and

FIG. 5 is a flowchart that schematically illustrates a method for a remote memory-set over a communication network, in accordance with an embodiment of the present invention.

### DETAILED DESCRIPTION OF EMBODIMENTS

### Overview

Remote Direct-Memory-Access (RDMA) allows direct memory access from the memory of one host into that of another, over a communication network, without involving either operating system or requiring computing power, thus allowing high-throughput, low-latency networking. RDMA is common in InfiniBand™ and Ethernet networks and is typically executed at the network adapter level (Host Channel Adapter (HCA) in InfiniBand or Network Interface Card (NIC) in Ethernet).

Typical RDMA implementations allow writing and reading to and from specified addresses, and include features such as virtual addressing, multicast transmissions, and others.

Computer programs sometimes need to write multiple copies of the same data to a range of addresses in memory. A common example is initializing a range in memory with zero values, but other fill values may also be used. Memory-Set (sometimes referred to as Memory-Fill) may be achieved by a plurality of RDMA-write instructions, but this would load the initiator host, the network, and the channel adapters of both hosts.

Embodiments of the present invention that are described herein provide methods and systems that remotely fill address ranges in a remote memory with multiple copies of specified data. We will refer to the computers that exchange data over the network as Compute Nodes. In the case of RDMA transactions, we will refer to an Initiator Compute Node that initiates the RDMA transfer, and to a Target Compute Node in which the remote memory is located.

In some embodiments, a network adapter of the Initiator Compute Node receives a remote memory-set request from a host and sends a corresponding remote memory-set instruction to the Target Compute Node; a Network Adapter of the Target Compute Node receives the instruction and fills the address range in the memory with the specified fill data, transparently to any host that the Target Compute Node may include. In embodiments, the remote memory-set request may comprise a start and an end address to specify the address range; in other embodiments, the request comprises a start address and a size.

In the request (from the host to the initiator's network adapter) and/or in the instruction (from (the initiator's network adapter to the target's network adapter), the fill data may be implicit (i.e., the op-code indicates the data to be filled, e.g., “remote memory-set-0”) or explicit (in the sense that the instruction/request comprises one or more attributes that specify the data to be filled). Similarly, in some embodiments the data type of the fill-data (e.g., byte, word, double-word, etc.) may be implicit or explicit.

In embodiments, the network adapter of the target compute node sends a response to the initiator compute node after executing the remote memory-set, indicating Success or Failure, and the initiator network adapter presents the response to the initiator host.

In some embodiments, the fill data comprises a single data value, which is specified once in the instruction and is to be written multiple times by the target. In other embodiments the fill data comprises some periodic pattern of data values, wherein the instruction specifies a single period.

Thus, in embodiments, a compute node can fill a remote memory in a target compute node with multiple copies of preset data, transparently to the hosts of both the initiator and the target, offloading the initiator and target processors.

More details and configurations will be disclosed in the description hereinbelow, with reference to example embodiments.

### System Description

RDMA may be used over InfiniBand, Ethernet, or any other suitable communication network. The embodiments to be disclosed hereinbelow refer to computers that are connected to a common communication network as Compute Nodes. We will further refer to the node that initiates a remote memory-set instruction as the Initiator Node, and to the node that comprises the target memory as a Target node (in embodiments, however, the Initiator and the Target nodes may occasionally switch tasks, i.e., a certain compute node may serve as an initiator in one RDMA transaction and as a target in another RDMA transaction). For brevity, we will further refer to the host and network adapter of the initiator node as Initiator host and Initiator Network Adapter (respectively), and to the host and network adapter of the target node as Target host and Target Network Adapter, respectively. We will refer to the memory of the target node as Target Memory.

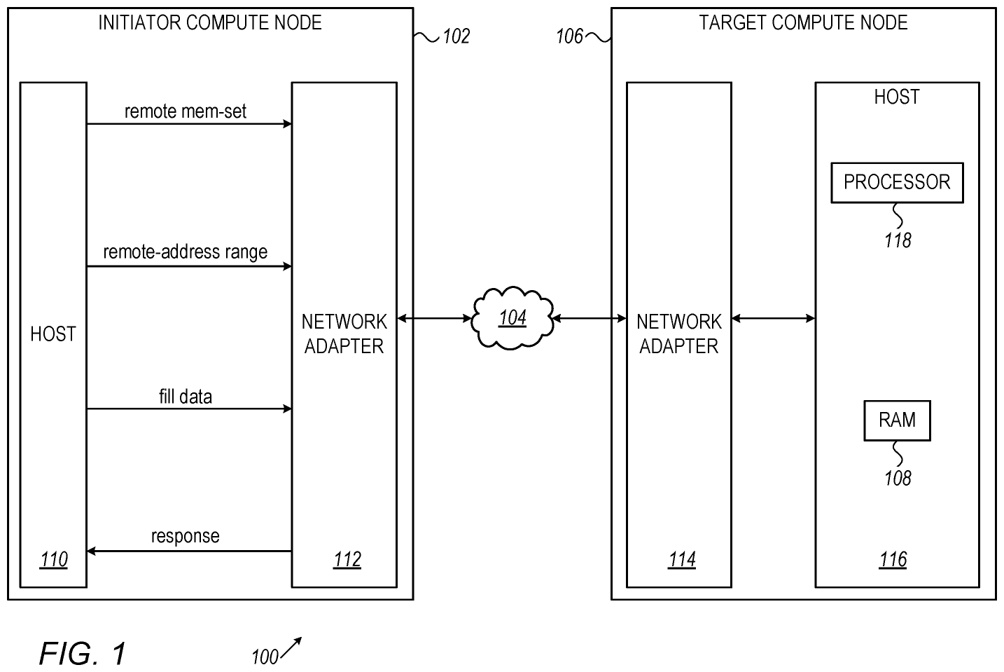

FIG. 1 is a block diagram that schematically illustrates a distributed compute system 100, including a pair of compute nodes that execute a remote memory-set instruction over a communication network, in accordance with an embodiment of the present invention.

The Distributed Compute System comprises an Initiator Node 102, a communication network 104 (e.g., InfiniBand or Ethernet) and a Target Node 106. Initiator Node 102 fills a range of addresses in a remote Target memory 108 (e.g., Random Access Memory, RAM) in Target Compute Node 106, over the network.

Initiator Node 102 comprises a Host 110 and a Network Adapter 112, such as a Host Channel Adapter (HCA) or a Network Interface Card (NIC). Target Node 106 similarly comprises a Network Adapter 114 (e.g., an HCA or a NIC) and a Host 116, which comprises the Target memory 104 and, typically, a processor 118 (or a plurality of processors).

In embodiments, prior to the RDMA session, the Initiator and Target nodes establish an RDMA connection through the network; this may include handshake negotiation, endpoint setup, Queue-Pair (QP) initialization, etc.

To fill a range within Target memory 108 with multiple copies of constant data, Initiator Host 110 sends a remote memory-set instruction to Initiator Network Adapter 112 and indicates an address range and a fill-data value. In response, Initiator Network Adapter 112 assembles a remote memory-set instruction and sends the instruction over the network using the pre-established RDMA connection, to the target node.

When the remote memory-set instruction reaches Target Node 106, Target Network Adapter 114 decodes the instruction and fills the requested range in Target memory 108 with multiple copies of the fill data. When the memory fill completes, successfully or unsuccessfully, the Target Network Adapter sends a response to the Initiator Node. The Initiator Network Adapter receives the response and sends it to the Initiator host.

Thus, the Initiator host may use a Remote Memory-Set request to fill an address range in the Target memory with multiple copies of preset data, offloading both hosts and operating systems and reducing redundant traffic over the network.

The configuration of distributed compute system 100 illustrated in FIG. 1 and described hereinabove is a simplified example that is chosen purely for the sake of conceptual clarity. Other configurations may be used in alternative embodiments. For example, in some embodiments, the requests and the responses are posted in buffers (e.g., queues), and executed according to a preset policy.

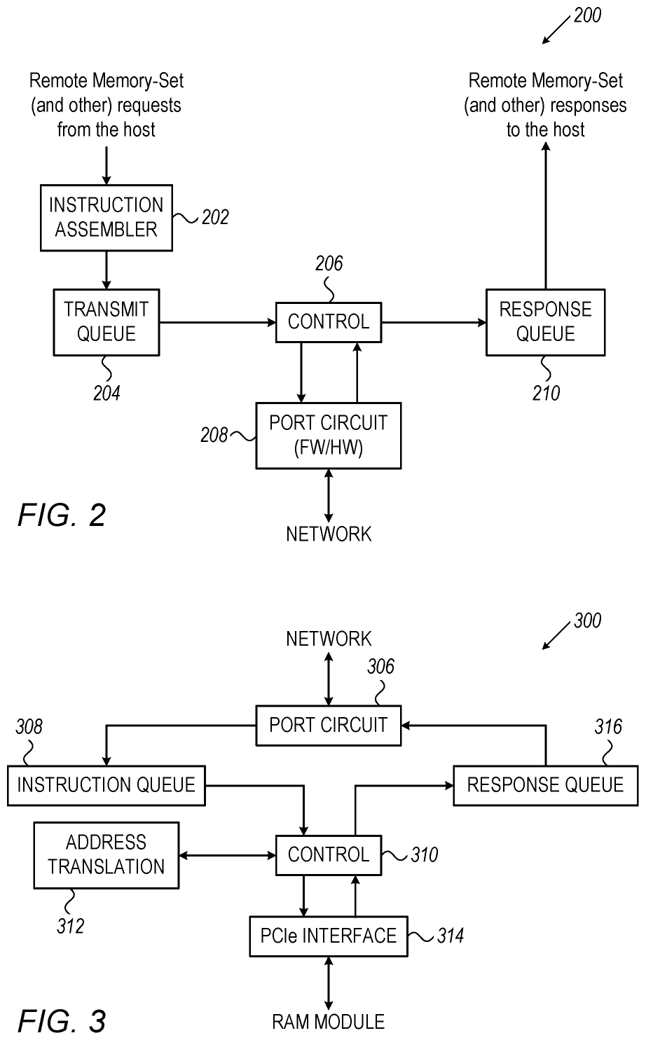

FIG. 2 is a block diagram that schematically illustrates an Initiator Network Adapter 200 (e.g., an HCA, or a NIC), in accordance with an embodiment of the present invention. Network Adapter 200 comprises a Transmit Queue 204, a Control circuit 206, a Port circuit 208, and a Response Queue 210.

A Host (not shown) of the Initiator node sends RDMA requests to the Network Adapter, including Remote-Memory-Set requests. Instruction Assembler 202 receives the requests, assembles corresponding RDMA instructions (e.g., adds a header and a footer, and sets operand fields according to the request's parameters) and sends the RDMA instruction to Transmit Queue 204. The Transmit Queue typically comprises a First-In-First-Out (FIFO) memory, to temporarily store RDMA instructions prior to execution.

Control Circuit 206 is configured to control the Network Adapter operation, including queue management and the egress and ingress of network packets. The Control Circuit sends packets responsively to the RDMA instructions to a Port Circuit 208, which comprises firmware (FW) and/or hardware (HW), to communicate packets with the network. In embodiments, Port Circuit 208 comprises the L1 (Physical) and L2 (MAC) layers circuitry.

In response to the RDMA instructions, the Target node may send Response messages (in the form of network packets) to the Initiator node. For Remote Memory-Set instructions, the response is typically an ACK or a NACK (e.g., instruction executed successfully, or instruction execution failed). For other RDMA instructions such as memory read, the response may include the requested data. The Port Circuit receives the response message packets from the network and forwards the responses to Control circuit 206. The Control circuit posts response messages in Response-Queue 210, which queues the responses in a FIFO buffer, and then sends the responses to the Initiator host. In some embodiments, Control Circuit 206 is configured to track the RDMA instructions and, for example, retry failed instructions.

The configuration of Initiator Network Adapter 200 illustrated in FIG. 2 and described hereinabove is cited by way of example. Other configurations may be used in alternative embodiments. For example, in an embodiment, Instruction Assembler circuit 202 is not used; the requests are stored in the queue, and the Control Circuit 206 assembles the requests to instructions. In another example, several remote memory-set instructions (and other types of instructions) are coalesced, to form fewer instructions and, thus, reduce the loading of the network.

FIG. 3 is a block diagram schematically illustrates a Target Network Adapter 300 (e.g., an HCA, or a NIC), in accordance with an embodiment of the present invention. We assume that the Target node includes a Peripheral Component Interconnect Express (PCIe) bus (other suitable busses may be used in alternative embodiments), and that the Target memory is connected to the PCIe bus, typically through a PCIe adapter. We will refer below to the target memory and the PCIe adapter circuit thereof collectively as the RAM Module.

The Network Adapter comprises a Port Circuit 306, which s configured to communicate packets with a communication network (e.g., InfiniBand or Ethernet), an Instruction Queue 308, configured to queue instructions (including remote memory set instructions) to the Target Node, a Control Circuit 310, which is configured to control the Network Adapter, an optional address translation circuit 312, to translate virtual memory address to physical memory locations, and a PCIe interface 314, to interface between the network adapter and the RAM module.

Communication packets that include remote memory-set instructions, sent by an Initiator Node, arrive at Port Circuit 306 (typically comprising the L1 (Physical) and L2 (MAC) layers circuitry); the port circuit sends the instructions to Instruction Queue 308. When ready, Control Circuit 310 reads and decodes the instructions and generates a corresponding set of memory-write transactions, to fill the requested address range with the requested data value.

In some embodiments, the address that the Initiator Compute Node sends is virtual; in this case, the Control Circuits obtains the corresponding physical address from Address Translation circuit 312.

PCIe Interface 314 receives the memory write transaction that the Control Circuit sends, and generates corresponding write cycles over a PCIe bus, to the RAM module. Thus, the remote memory-set instruction will result in a series of PCIe write cycles, to fill the address range remote memory with the requested data.

The RAM module may send an Acknowledge signal, indicating write success or write failure, to the Control Circuit. The Control Circuit, after receiving Success acknowledges for all the write cycles that correspond to the remote memory-write instruction, may post a Success response in Response Queue 316, which will forward the response over the network, to the Initiator Node. If any of the write cycles fails, the Control Circuit will post a Failure response in the Response Queue; in some embodiments, the control circuit will attempt to rewrite failing write cycles, and will send a Failed response only after a preset number of repeated write attempts fail.

The following example demonstrates the operation of Target Network Adapter 300. The Initiator Node sends a Remote Memory-Set instruction, to fill the address range 0x1200000 to 0x12000FF of a remote memory (e.g., a RAM) with 0xFF. The RAM can be accessed in widths of byte (8 bits), word (16 bits) or double word (32 bits). The virtual address range is mapped to locations 0x32000 to 0x320FF of a RAM in the Target Compute Node. Address Translation circuit 312 is preloaded with virtual to physical translation tables. Control Circuit 310 receives the remote memory set instruction and generates 64 double-word write cycles (to fill four byte-locations at each cycle), from address 0x320000 to address 0x320FC, with data=0xFFFFFF. If the address range is not an integer number of double words, the Control Circuit may issue a combination of double word, word and byte write operations, to optimally cover the required address range.

The configuration of Target Network Adapter 300 illustrated in FIG. 3 and described above, is cited by way of example. Other configurations may be used in alternative embodiments. For example, in an embodiment, responses from multiple instructions (remote memory-set and others) are coalesced, to reduce the loading of the network.

### Variations of the Remote Memory-Set Request/Instruction.

In embodiments, various configurations and formats of the remote-memory set request (sent by the Initiator host) and the ensuing remote memory-set instruction (sent by the network adapter) may be used (the list below refers to remote memory-set requests sent by the Initiator host but may also be applicable to remote memory instructions sent by the network adapter).
1. Implicit vs. explicit fill data—in some embodiments the fill data is implicit (e.g., a remote memory-set-0 request, in which the fill data is always 0). In other embodiments, the fill data is specified in the remote memory-set request.
2. The address range to be filled by the remote memory-set is set, in some embodiments, by a Start Address and an End Addresses; in other embodiments, the range is set by a Start address and a Size.
3. Fill data type. In some embodiments the fill data type is constant (e.g., 32 bits); in other embodiments several data types may be used (e.g., 8-bit (byte), 16-bit (word), 32-bit (double-word) or 64-bit (quad-word)), wherein the type is defined implicitly by the remote memory-set request (for example, an embodiment may support a remote memory-set-b request, a remote memory-set-w request and a remote memory-set-dw request, for byte, word and double-word data types, respectively. In other embodiments the data type is explicit.
4. Interval-Fill. In some embodiments, a single remote memory-set request may be used to fill multiple intervals in the memory with fixed data. For example, a remote memory-fill-interval request may comprise a address first parameter, several intervals parameter, an interval size parameter, and then several fill-values; wherein multiple copies of the first fill value will be written to the first interval, multiple copies of the second fill value will be written to the second interval, and so on.
5. Hybrid remote-memory-set requests: in an embodiment, one or more request types may be combined; for example: fill a first range with 0, and then fill multiple 4 Kbyte intervals with preset fill data.

Other variations may be used, e.g., remote-memory-block-set, wherein the fill size is either constant (e.g., 1 Kbyte) or preset.

In embodiments, a network adapter may support some or all the remote memory-set variations described above.

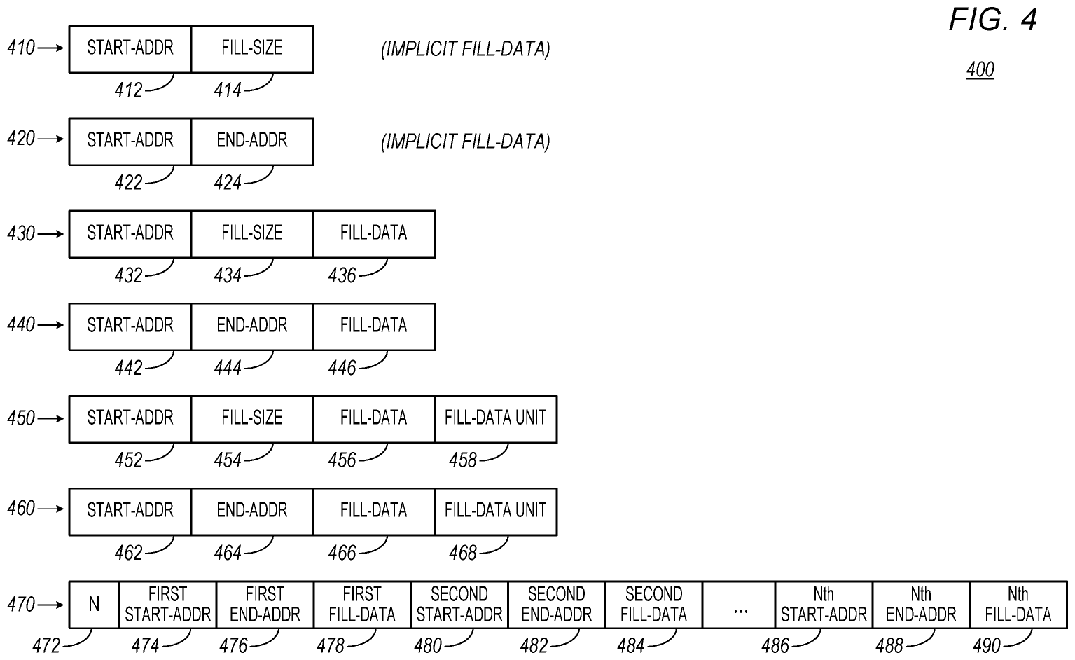

FIG. 4 is a diagram that schematically describes various Remote-Memory-Set request (and remote memory-set instructions) formats 400, in accordance with an embodiment of the present invention. An Implicit-Data-Start-Address—and—Size format 410 comprises a Start-Address field 412 and a size field 414. The fill data is implicit; for example, a Remote Memory-Set-0 instruction can be used to fill the address range with data=0, and a Remote Memory-Set-FF can be used to fill the address range with data=0xFF.

An Implicit-Data-Start-Address-and-End-Address format 420 comprises a Start-Address field 422, which specifies the first address, and an End-Adress field 424, which specifies the last address of the fill range; the data value is, again, implicit.

Other formats explicitly indicate the data value. An Explicit-Data-Start-Address—and—Size format 430 comprises a Start-Address field 432, a size field 434 and a data-value field 436; Similarly, An Explicit-Data-Start-Address-and-End-Address format 440 comprises a Start-Address field 442, a size field 444 and a data-value field 446.

The data-value unit in the formats described above is implicit—for example, in an embodiment, the data unit is always a byte (and, hence, fields 436 and 446 comprise 8-bits). In other embodiments, other implicit data units, such as Word or Double-Word, may be used.

In yet other embodiments, the data unit is an explicit field in the remote-memory-set request. For example, an Explicit-Data-Start-Address-Size-and-Data-Unit format 450 comprises a Start-Address field 452, a size field 454, a data-value field 456 and a data unit field 458. The data unit field may comprise two bits, to indicate a byte, a word, a double-word or a quad-word (64 bis) data type. Similarly, An Explicit-Data-Start-Address-End-Address-and-Data-Unit format 460 comprises a Start-Address field 462, an End Address field 464, a data-value field 466 and a Data Unit field 468.

In some embodiments, more complex memory-fill requests are used. For example, a Multiple-Fill format 470 comprises an N field 472 that specifies the number of segments in the memory, a First Start-Address field 474 and a First End-Address field 476 specify the Start and End addresses of the first memory segment, while a First Fill-Data field 478 specifies the fill data of the first segment; a Second Start-Address field 480 and a Second End-Address field 482 specify the Start and End addresses of the second memory segment, while a Second Fill-Data field 484 specifies the fill data of the second segment.

More sets of Start-Address-End-Address-Fill-Data fields follow; the last three fields—an Nth Start-Address field 486, an Nth End-Address field 488 and an Nth Field 490 specify the Start address, end address and fill data of the last memory segment.

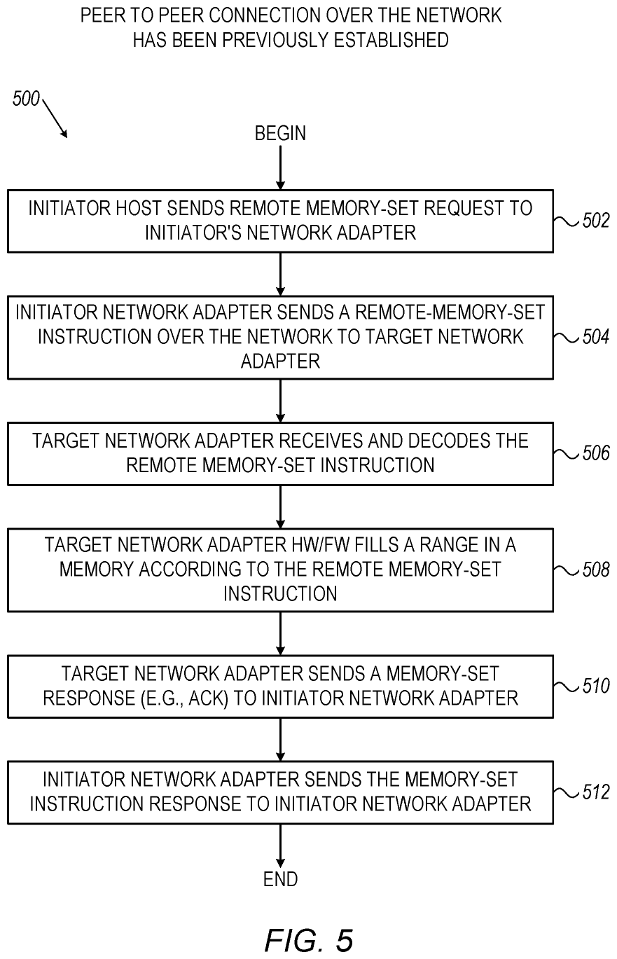

FIG. 5 is a flowchart that schematically illustrates a method 500 for a remote memory-set over a communication network, in accordance with an embodiment of the present invention. The flowchart is executed by an Initiator Node that comprises an Initiator Host and an Initiator Network Adapter, and by a Target Node that comprises a Target Network Adapter and a Target memory. It is assumed that, prior to the flowchart, a connection is established between the Initiator Node and the Target Node.

The flowchart starts at a Send-Remote-Set-From-Host operation 502, wherein the Initiator Host sends a Remote-Memory-Set request to the Initiator Network Adapter. At a Send-Remote-Set-From-Network-Adapter operation 504, the Initiator network Adapter builds a corresponding remote-set-memory instruction and sends the instruction in a suitable communication packet over the network, to the Target Node.

Next, at a Receive-Remote-Memory-Set operation 506, the Target Network Adapter receives and decodes the remote-memory-set instruction, and, at a Fill-Memory operation 508 fills the range of addresses at the target memory with the required data.

The Target Network Adapter then, at a Send-Response operation 510, sends an acknowledge packet, (which may indicate, for example, success or failure) to the Initiator Node. Lastly, at an Indicate Response to Host operation 512, the Initiator Network Adapter sends the response to the Initiator host (e.g., sends a completion indication with a success or a failure flag).

The flowchart illustrated in FIG. 5 and described hereinabove is cited by way of example. Other flowcharts may be used in alternative embodiments. For example, in an embodiment, the Target Network Adapter will retry failed remote-memory-set instructions and will send a failure response to the Initiator only if the fill operation keeps failing. In other embodiments, the Initiator Network Adapter will retry the instruction, and notify a failure to the Initiator host only if the Remote-Memory-Set instruction repeatedly fails.

The configuration of Initiator Node 102, Target Node 106, Initiator Network Adapter 200, Target Network Adapter 300, Remote-Memory-Set request formats 500, and the method of flowchart 500, illustrated in FIGS. 1 through 5, are example configurations and flowcharts that are depicted purely for the sake of conceptual clarity. Any other suitable configurations and flowcharts can be used in alternative embodiments. The network adapters and components thereof may be implemented using suitable hardware, such as in one or more Application-Specific Integrated Circuit (ASIC) or Field-Programmable Gate Arrays (FPGA), using software, using hardware, or using a combination of hardware and software elements.

In some embodiments, Initiator Node 102 and/or Target Node 106, including components thereof, may be implemented using one or more general-purpose programmable processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

Although the embodiments described herein mainly address remote memory-set operations over a communication network, the methods and systems described herein can also be used in other applications, such as in storage controllers (e.g., hard-disk or Non-Volatile Memory), which can fill a range in the controlled storage responsively to a CPU command. One example of a storage controller is a Non-Volatile Memory express (NVMe) controller. Such a storage controller typically comprises a host interface, a memory interface and a processor. The host interface communicates with a host. The memory interface accesses a memory (volatile or non-volatile). The processor typically receives from the host, via the host interface, a command specifying one or more address ranges and one or more fill-data values. In response to the command, the processor fills the specified address range(s) in the memory with multiple copies of the specified fill-data value(s), by writing the fill-data value(s) multiple times to the address range(s). In some embodiments the command includes an address-range indicator that indicates the address range(s). In some embodiments the command includes a fill-data indicator that indicates the fill-data value(s).

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A network adapter, comprising:
a port, to connect to a communication network; and
circuitry, to send to a remote network adapter, via the communication network, a remote memory-set instruction that instructs the remote network adapter to fill one or more address ranges in a memory with multiple copies of one or more fill-data values.

2. The network adapter according to claim 1, wherein the remote memory-set instruction comprises an address-range indicator that indicates the one or more address ranges.

3. The network adapter according to claim 1, wherein the remote memory-set instruction comprises a fill-data indicator that indicates the one or more fill-data values.

4. The network adapter according to claim 1, wherein the circuitry is to receive, from a host, a command specifying the one or more address ranges and the one or more fill-data values, and to send the remote memory-set instruction in response to the command.

5. A network adapter, comprising:
a port, to connect to a communication network; and circuitry, to:
receive from a remote network adapter, via the communication network, a remote memory-set instruction that instructs the network adapter to fill one or more address ranges in a memory with multiple copies of one or more fill-data values; and
execute the remote memory-set instruction, by writing the one or more fill-data values multiple times to the one or more address ranges.

6. The network adapter according to claim 5, wherein the remote memory-set instruction comprises an address-range indicator that indicates the one or more address ranges.

7. The network adapter according to claim 5, wherein the remote memory-set instruction comprises a fill-data indicator that indicates the one or more fill-data values.

8. A method, comprising:
in a network adapter, connecting to a communication network; and
sending, from the network adapter to a remote network adapter, via the communication network, a remote memory-set instruction that instructs the remote network adapter to fill one or more address ranges in a memory with multiple copies of one or more fill-data values.

9. The method according to claim 8, wherein sending the remote memory-set instruction comprises indicating in the remote memory-set instruction an address-range indicator that indicates the one or more address ranges.

10. The method according to claim 8, wherein sending the remote memory-set instruction comprises indicating in the remote memory-set instruction a fill-data indicator that indicates the one or more fill-data values.

11. The method according to claim 8, wherein sending the remote memory-set instruction comprises receiving, from a host, a command specifying the one or more address ranges and the one or more fill-data values, and sending the remote memory-set instruction in response to the command.

12. A method, comprising:
in a network adapter, connecting to a communication network;
receiving in the network adapter, from a remote network adapter, via the communication network, a remote memory-set instruction that instructs the network adapter to fill one or more address ranges in a memory with multiple copies of one or more fill-data values; and
executing the remote memory-set instruction using the network adapter, by writing the one or more fill-data values multiple times to the one or more address ranges.

13. The method according to claim 12, wherein receiving the remote memory-set instruction comprises receiving in the remote memory-set instruction an address-range indicator that indicates the one or more address ranges.

14. The method according to claim 12, wherein receiving the remote memory-set instruction comprises receiving in the remote memory-set instruction a fill-data indicator that indicates the one or more fill-data values.

15. A storage controller, comprising:
a host interface, to communicate with a host;
a memory interface, to access a memory; and
a processor, to:
receive from the host, via the host interface, a command specifying one or more address ranges and one or more fill-data values; and
in response to the command, fill the one or more address ranges in the memory with multiple copies of the one or more fill-data values, by writing the one or more fill-data values multiple times to the one or more address ranges.

16. The storage controller according to claim 15, wherein the command comprises an address-range indicator that indicates the one or more address ranges.

17. The storage controller according to claim 15, wherein the command comprises a fill-data indicator that indicates the one or more fill-data values.
